(19) United States
(12) Patent Application Publication
(10) Pub. No.: US 2013/0308906 A1
(43) Pub. Date: Nov. 21, 2013

(54) SYSTEM AND METHOD FOR DENSE COUPLING BETWEEN OPTICAL DEVICES AND AN OPTICAL FIBER ARRAY

(71) Applicants: Dawei Zheng, Irvine, CA (US); Ningning Feng, Arcadia, CA (US); Xiaochen Sun, Pomona, CA (US)

(72) Inventors: Dawei Zheng, Irvine, CA (US); Ningning Feng, Arcadia, CA (US); Xiaochen Sun, Pomona, CA (US)

(73) Assignee: LaXense, Inc., Walnut, CA (US)

(21) Appl. No.: 13/476,668

(22) Filed: May 21, 2012

(51) Int. Cl. G02B 6/30; B44C 1/22; B23P 17/00

(52) U.S. Cl. 385/49; 29/592; 29/428; 216/24

(57) ABSTRACT

An optical system and method for coupling optical devices and an optical fiber array are provided. The optical system includes a substrate comprising a first side and a second side facing generally opposite to the first side. The optical system further includes at least one optical waveguide extending along at least a portion of the first side, at least one hole extending from the second side towards the first side, and at least one reflective element at the first side. The at least one reflective element is in optical communication with the at least one optical waveguide and with the at least one hole. The at least one reflective element is configured to deflect light between the at least one optical waveguide and the at least one hole.

### BACKGROUND

1. Field

The present application relates generally to optical micro-assemblies, and more particularly, to systems and methods for coupling light between a fiber array and an array of optical devices, such as an array of edge emitting light sources or an array of detectors.

2. Description of the Related Art

Optoelectronic systems used for communication usually consist of a light transmitter and a receiver. The light transmitter usually consists of a light emitting device, light coupling elements (such as lenses, mirrors, gratings), and a fiber used to carry light signals along a distance. The receiver usually consists of a detector, light coupling elements, and a fiber. Waveguides are sometimes used to route light signal on a chip or board locally. When the light emitting device is an edge emitting device, e.g. a distributed feedback reflector (DFB) or Fabry-Perot laser, a lens is usually positioned between the laser and the fiber. Due to the mode mismatch between the edge emitting device and a single mode fiber, in addition to the small laser mode size, the alignment of laser, lens, and fiber is active, so the light source or the detector is powered. Furthermore, this process typically needs precision mechanics and laser welding to fix one part relative to another, it is therefore expensive.

Often optoelectronic communication systems include a plurality of light transmitters, detectors, and fibers in an array configuration. Under this circumstance, packaging density has practical technological and as well as economic importance. A laser or detector array, a lens array, with a fiber array in parallel configuration of equal spacing is the classical approach to package such devices. Due to the limited bending radius of the fiber, the conventional approach is naturally suitable to accommodate a one-dimensional fiber array. In practical implementation, the fibers are positioned at either the edge of a semiconductor die off the chip, or disposed into V-grooves on the semiconductor die.

### SUMMARY

An optical system is provided. The optical system comprises a substrate comprising a first side and a second side facing generally opposite to the first side. The optical system further comprises at least one optical waveguide extending along at least a portion of the first side. The optical system further comprises at least one hole extending from the second side towards the first side. The optical system further comprises at least one reflective element at the first side. The at least one reflective element is in optical communication with the at least one optical waveguide and with the at least one hole. The at least one reflective element is configured to deflect light between the at least one optical waveguide and the at least one hole.

The at least one optical waveguide can comprise an array of optical waveguides, the at least one hole can comprise an array of holes, and the at least one reflective element can comprise an array of reflective elements. The substrate can comprise a semiconductor material (e.g., silicon), the at least one optical waveguide can comprise silicon, and the substrate can comprise an oxide layer between the at least one hole and the at least one optical waveguide.

The substrate can comprise at least one focusing element between the at least one hole and the at least one reflective element. The at least one focusing element can be configured to focus light propagating through the at least one focusing element and between the at least one hole and the at least one reflective element.

The at least one hole can have a generally circular cross-section in a plane generally perpendicular to the at least one hole, and the generally circular cross-section can have a diameter between 125 microns and 150 microns. The at least one hole can comprise a first portion extending a first distance from the second side towards the first side. The first portion can have a first cross-sectional shape in a plane generally perpendicular to the first portion, the first cross-sectional shape having a first geometric parameter. The at least one hole can further comprise a second portion extending a second distance from the first portion towards the first side. The second portion can have a second cross-sectional shape in a plane generally perpendicular to the first portion. The second cross-sectional shape can have a second geometric parameter smaller than the first geometric parameter. The at least one hole can be configured to receive a portion of an optical fiber and an adhesive configured to affix the portion of the optical fiber within the at least one hole.

The optical system can further comprise at least one optical fiber within the at least one hole and in optical communication with the at least one reflective element. The optical system can further comprise at least one optical device in optical communication with the at least one optical waveguide. The at least one optical device comprises at least one light source or at least one light detector.

A method of coupling light between at least one optical fiber and at least one optical device is provided. The method comprises providing an optical system comprising a substrate comprising a first side and a second side facing generally opposite to the first side. The optical system further comprises at least one optical waveguide extending along at least a portion of the first side. The optical system further comprises at least one hole extending from the second side towards the first side. The optical system further comprises at least one reflective element at the first side. The at least one reflective element is in optical communication with the at least one optical waveguide and with the at least one hole. The at least one reflective element is configured to deflect light between the at least one optical waveguide and the at least one hole. The method further comprises providing at least one optical device in optical communication with the at least one optical waveguide. The method further comprises providing at least one optical fiber within the at least one hole such that the at least one optical fiber is in optical communication with the at least one reflective element. The method further comprises transmitting light between the at least one optical device and the at least one optical fiber. The transmitted light propagates through the at least one optical waveguide, is reflected by the at least one reflective element, and propagates through the at least one hole.

A method of fabricating an optical system is provided. The method comprises providing a first substrate comprising a first side and a second side facing generally opposite to the first side. The method further comprises forming at least one optical waveguide extending along at least a portion of the first side. The method further comprises forming at least one hole extending from the second side towards the first side. The method further comprises forming at least one reflective element at the first side. The at least one reflective element is in optical communication with the at least one optical waveguide and with the at least one hole. The at least one reflective element is configured to deflect light between the at least one optical waveguide and the at least one hole.

The first substrate can comprise an optical layer at the first side, the optical layer comprising a core layer and a lower cladding layer. Forming the at least one optical waveguide can comprise etching the optical layer and forming an upper cladding layer on the core layer.

Forming the at least one reflective element can comprise shaping a portion of the optical layer using gray-scale mask lithography followed by reactive-ion etching using the first substrate as an etch stop. Forming the at least one reflective element can comprise depositing a barrier layer over the optical layer, forming a hole in the barrier layer to expose the underlying optical layer, and anisotropically etching a portion of the underlying optical layer.

Forming the at least one hole can comprise etching the first substrate from the second side towards the first side. Forming the at least one hole can further comprise forming at least one focusing element between the at least one hole and the at least one reflective element. The at least one focusing element can be configured to focus light propagating through the at least one focusing element between the at least one hole and the at least one reflective element. Forming the at least one focusing element can comprise shaping a portion of the first substrate using gray-scale mask lithography followed by reactive-ion etching.

Etching the first substrate from the second side towards the first side can comprise forming a first portion of the at least one hole by etching the first substrate. The first portion can extend a first distance from the second side towards the first side. The first portion can have a first cross-sectional shape in a plane generally perpendicular to the first portion, the first cross-sectional shape having a first perimeter. Etching the first substrate can further comprise forming a second portion of the at least one hole by etching the first substrate. The second portion can extend a second distance from the first portion towards the first side. The second portion can have a second cross-sectional shape in a plane generally perpendicular to the first portion, the second cross-sectional shape having a second perimeter smaller than the first perimeter.

The method can further comprise inserting at least one optical fiber into the at least one hole until the second portion of the at least one hole stops the insertion of the at least one optical fiber. The method can further comprise placing at least one optical device in optical communication with the at least one optical waveguide. The at least one optical device can comprise at least one light source residing on a second substrate, and the method can further comprise placing the at least one optical device in optical communication with the at least one optical waveguide comprises coupling the second substrate to the first substrate. The at least one optical device can comprise at least one light detector, and the method can comprise placing the at least one optical device in optical communication with the at least one optical waveguide comprises forming the at least one light detector at the first side.

### BRIEF DESCRIPTION OF THE DRAWINGS

FIG. 1A schematically illustrates a trimetric view of an example optical system (e.g., a semiconductor optical bench) configured to densely-couple optical devices (e.g., edge emitting light sources or photodetectors) to optical fibers in accordance with systems and methods disclosed herein.

FIG. 1B schematically illustrates a cross-sectional view of a portion of the example optical system of FIG. 1A in the plane 12 in FIG. 1A.

FIG. 1C schematically illustrates a cross-sectional view of a waveguide and substrate of an example optical system in a plane perpendicular to the plane 12 in FIG. 1A in accordance with systems and methods disclosed herein.

FIG. 2 schematically illustrates a top down view of an example hole etched into the second side (e.g., backside) of the substrate (e.g., semiconductor chip).

FIGS. 3A-3E schematically illustrate an example process flow using a series of cross-sectional views of the formation of the waveguides, reflective elements, lenses, and holes for fiber insertion by way of the second side of the substrate in accordance with systems and methods disclosed herein.

FIG. 4A schematically illustrates a cross-sectional view of an example optical system in which the substrate comprises a silicon-on-insulator (SOI) wafer and the optical device comprises a light source in accordance with systems and methods disclosed herein.

FIG. 4B schematically illustrates a cross-sectional view of an example optical system in which the substrate comprises a silicon-on-insulator (SOI) wafer and the optical device comprises a waveguide detector such that light transmitted by the waveguide is directly coupled into the waveguide detector in accordance with systems and methods disclosed herein.

FIG. 4C schematically illustrates a cross-sectional view of an example optical system in which the substrate comprises a silicon-on-insulator (SOI) wafer and the optical device comprises a waveguide detector such that light transmitted by the waveguide is evanescently coupled into the waveguide detector in accordance with systems and methods disclosed herein.

FIGS. 5A-5D schematically illustrate an example process flow using a series of trimetric views of the formation of the waveguide and the waveguide detector of FIG. 4B in accordance with systems and methods disclosed herein.

FIG. 6 is a flow diagram of an example method or process flow for fabricating an example optical system in accordance with systems and methods disclosed herein.

FIG. 7A is a flow diagram of an example process flow to assemble an edge emitting laser to an example optical system so as to couple light from the laser to a fiber in accordance with systems and methods disclosed herein.

FIG. 7B is a flow diagram of an example process flow to assemble a waveguide detector to an example optical system device so as to couple light from a fiber to the detector in accordance with systems and methods disclosed herein.

### DETAILED DESCRIPTION

The number of fibers connected to a chip within a unit length in a conventional device as described above is quite limited. Certain systems and methods disclosed herein advantageously employ micro-electromechanical system techniques developed in the semiconductor technology to couple light from an edge emitting light source into a large waveguide residing on a substrate, and then steer the light inside the waveguide into fiber arrays inserted into pre-aligned holes or vias in the substrate. Since the position relationship between the laser die (e.g., flip-chip bonded onto the substrate), the waveguide, the steering mirror (e.g., etched into the waveguide), and the hole in the substrate can be precisely defined by the optical lithography process, passive alignment can advantageously be employed to replace the expensive active alignment steps.

Since the fibers can be perpendicular to the semiconductor wafer, and can be plugged into the wafer backside, the packing density in certain systems and methods advantageously can be not limited by the fiber bending radius. Instead, the size of the optical devices (e.g., the light sources and detectors) plus the driver electronics can become the packaging density limiting factor. Since the fibers are removed from the front side of the semiconductor wafer, more real estate can be advantageously available for added chip functionality.

An example optical device (e.g., a semiconductor optical bench device) and example methods of using such devices to couple a two-dimensional (2D) array of optical devices (e.g., light sources or detectors) into a 2D array of optical fibers are disclosed in more detail below.

Flip-chip bonding can be used to position edge emitting light sources onto a semiconductor optical bench device, and to align the light emitting facet to a waveguide which comprises an elongated waveguide core portion having a rectangular or ridge shape cross-section. The gap between the light emitting facet of the light source and the receiving waveguide facet can be configured such that the coupling satisfies the far field requirement. In addition, the waveguide cross-sectional dimensions can be sized such that a substantial amount of light is coupled into the waveguide. A mirror can be patterned into the end of the waveguide by gray-scale lithography and Reactive Ion Etching (RIE) or by regular lithography followed by anisotropic wet etch to reveal certain crystallography planes of the semiconductor. Light traveling in the waveguide can then be deflected into the substrate by this mirror, and into the fiber which has been inserted into the via holes in the substrate.

Deep Reactive Ion Etching (DRIE), developed in the semiconductor industry, can be used to make precise via holes in the backside of the semiconductor die. Via holes of two different sizes can be etched co-axially into the chip backside, resulting in a single hole with two cross-sectional shapes and sizes. The larger sized portion of the hole (e.g., having a larger cross-sectional diameter) can be sized to allow a standard fiber to be inserted within the larger sized hole, which can prevent the fiber from experiencing any off-axis movement and can provide lateral mechanical support. The smaller sized portion of the hole (e.g., having a smaller cross-sectional diameter) can be sized to provide a mechanical stop to the fiber when it is inserted into the larger sized hole, and can let a substantial amount of light to pass through the semiconductor substrate, reaching the angled mirror etched into the semiconductor waveguide disposed on the front-side of the die. In consequence, light from the fiber can be coupled into the waveguide, which is transparent to the signal light, before it gets to a waveguide detector through either direct or evanescent coupling.

The optical device can comprise a lens etched into the backside of the substrate using gray-scale lithography followed by RIE. Since the lens can help to focus the light coming out of the fiber inserted into the via hole onto the reflection mirror, the fiber end does not have to be very close to the aforementioned reflection mirror, thereby advantageously giving more etch tolerance to the via hole formation step, which can be a timed RIE process.

The optical device can also comprise a silicon-on-insulator substrate, in which the light signal carrying waveguide can be made of a top silicon layer, with an oxide layer residing between the top silicon layer and the underlying substrate, which can also comprise a silicon layer. Due to the presence of this oxide layer, the inner via hole can be etched to stop at this oxide layer. In consequence, the outer via hole can be brought very close to the mirror in the waveguide, and therefore the inserted fiber can get close to the mirror, and a lens at the end of the via hole can be omitted.

The details of the following description, made with reference to the accompanying drawings, may be found individually or combined with one another various permutations and subsets in accordance with the systems and methods disclosed herein. The example systems and methods may, however, be embodied in many different forms and should not be construed as being limited to any one particular example set forth herein. As used herein, “forming” a structure shall be given its broadest ordinary meaning, including but not limited to performing steps to make the structure or providing the structure already premade. As used herein, the term “layer” shall be given its broadest ordinary meaning including but not limited to a layer comprising a single material and having a generally uniform thickness or a varying thickness, or multiple sublayers each comprising a different material and each having either a uniform thickness or a varying thickness. In the drawings, the thicknesses of the layers and the widths of certain parts are exaggerated for clarity.

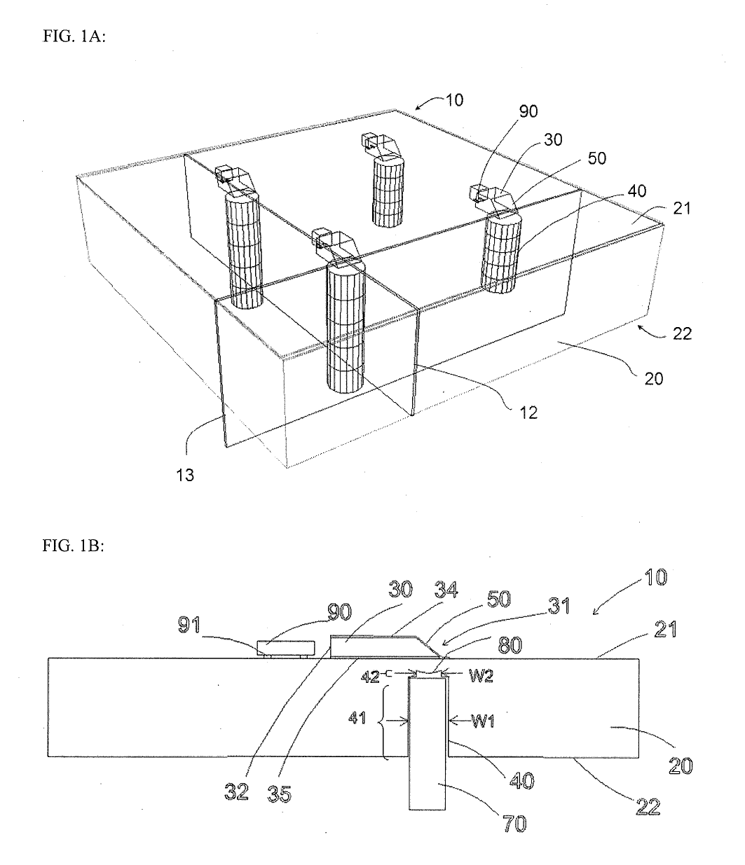

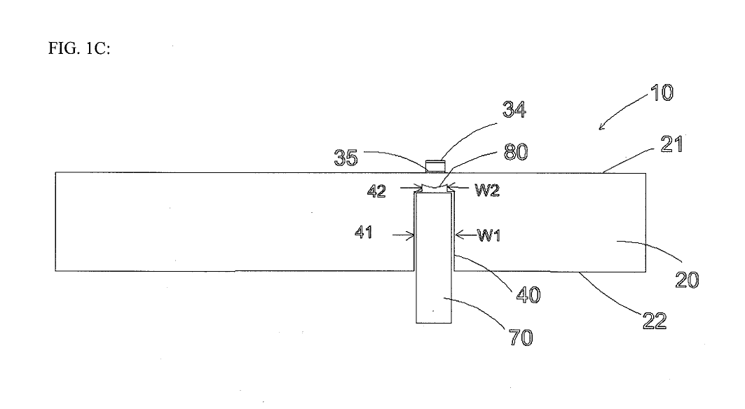

FIG. 1A schematically illustrates a trimetric view of an example optical system 10 (e.g., a semiconductor optical bench device) in accordance with the description provided herein. FIG. 1B schematically illustrates a cross-sectional view of a portion of the example optical system 10 of FIG. 1A in the plane 12 marked in FIG. 1A. The example optical system 10 is shown in FIG. 1B with a different angle of view and with features having different relative scales as those in FIG. 1A to show various details. The optical system 10 comprises a substrate 20 comprising a first side 21 and a second side 22 facing generally opposite to the first side 21. The optical system 10 further comprises at least one optical waveguide 30 extending along at least a portion of the first side 21. The optical system 10 further comprises at least one hole 40 extending from the second side 22 towards the first side 21. The optical system 10 further comprises at least one reflective element 50 at the first side 21. The at least one reflective element 50 is in optical communication with the at least one optical waveguide 30 and with the at least one hole 40. The at least one reflective element 50 is configured to deflect light between the at least one optical waveguide 30 and the at least one hole 40.

The substrate 20 can comprise a semiconductor chip comprising one or more semiconductor materials (e.g., silicon, silicon-germanium alloy, gallium arsenide, indium phosphide, indium gallium arsenide, or aluminum indium gallium arsenide). The substrate 20 can also comprise one or more layers of different materials such that the first side 21 (e.g., the front side) of the substrate 20 can comprise a different material than the second side 22 (e.g., the back side) of the substrate 20, or the first side 21 and the second side 22 of the substrate 20 can comprise the same material as one another but that is different than a material within the substrate 20 between the first side 21 and the second side 22. For example, the substrate 20 can comprise a silicon-on-insulator structure in which the first side 21 comprises silicon, the majority of the underlying substrate 20 comprises silicon, and having an oxide layer between the first side 21 and the underlying portion of the substrate 20. Example thicknesses of the oxide layer can be between 0.375 micron and 5 microns, and example thicknesses of the silicon-on-insulator layer can be between 0.25 micron and 13 microns. The thickness of the substrate 20 between the first side 21 and the second side 22 can be in a range between about 200 microns and about 2000 microns, and is typically smaller than either the width or the length of the substrate 20. One or both of the first side 21 and the second side 22 can have a smooth surface (e.g., by being polished) prior to any subsequent process steps are implemented.

The at least one optical waveguide 30 can comprise an array of optical waveguides 30 residing on the first side 21 of the substrate 20 and that are spaced from one another at predetermined intervals at the first side 21. For example, the waveguide 30 can have a width along the first side 21 in a range between 2 microns and 13 microns, and can have a height above the first side 21 in a range between 2 microns and 13 microns. The waveguide 30 can have an elongated rectangular or ridge shape, can be straight or curved, and can have a length in a range between 100 microns and 1 centimeter. FIG. 1C schematically illustrates a cross-sectional view of an example waveguide 30 in accordance with the systems and methods disclosed herein. Each waveguide 30 can comprise one or more semiconductor materials (e.g., silicon), and can have an elongated shape with a first end 31, a second end 32, a core 33, an upper cladding 34, and a lower cladding 35. The second end 32 can be flat with a surface normal direction having a small angle or parallel to the elongated direction of the waveguide 30 (e.g., to deflect back-reflected light from the light source 90 away from the emitting surface of the light source 90. For example, the core 33 can have a rectangular or ridge-like cross-sectional shape, the lower cladding 35 can comprise a flat layer with a thickness in a range between 0.1 micron and 10 microns, and the upper cladding 34 can comprise a flat layer generally following the outer shape of the core 33 with a thickness in a range between 0.1 micron and 10 microns. The waveguide core can have a width between 0.25 micron and 13 microns, and can have a thickness between 0.25 micron and 13 microns. Both the lower cladding 35 and the upper cladding 34 can comprise a material having an optical index lower than that of the material or materials of the core 33. In addition, the core 33, the lower cladding 35, and the upper cladding 34 can be made of materials different from one another and different from that of the substrate 20. For example, if the core 33 is formed from silicon, the lower cladding 35 can comprise silicon dioxide or silicon nitride, and the upper cladding 34 can comprise silicon dioxide, silicon nitride, silicon oxy-nitride, or one or more polymer materials. The at least one waveguide 30 of the systems and methods disclosed herein can be formed using photolithographic techniques, for example, by reactive ion etching (RIB) using a rectangular shape photo-mask.

The at least one reflective element 50 can comprise an array of reflective elements 50 at the first side 21. For example, the array of reflective elements 50 can comprise a reflective element 50 formed at the first end 31 of each optical waveguide 30 of the at least one optical waveguide 30 disclosed above. Example reflective elements 50 (e.g., mirrors, surfaces, layers) compatible with the systems and methods disclosed herein can comprise an integral portion of the corresponding waveguide 50 (e.g., a fully or partially reflective face of the waveguide 30 at the first end 31 of the waveguide 30) or can comprise a structure separate from the waveguide 30. The reflective element 50 can comprise one or more semiconductor materials, and can have one or more layers (e.g., one or more metallic layers, one or more dielectric layers, or both) that are configured to enhance the reflectivity of the reflective element 50 at one or more wavelengths. For example, the reflective element 50 can be formed by depositing a thin metal layer (e.g., nickel, aluminum) onto an etched surface of silicon to reflect light having a wide range of wavelengths. The reflective element 50 can be in paraboloid shape, e.g., to focus light from the waveguide 30 into the receiving fiber inserted into the backside 22. The reflective element 50 can comprise an anti-reflective coating on a mirror, such that a substantial amount of light from the waveguide 30 is reflected downward into the corresponding hole 40. For example, the anti-reflective coating material can comprise any one, two, or alternating layers of silicon dioxide, silicon nitride, silicon oxy-nitride, and zirconium oxide.

The at least one reflective element 50 of the systems and methods disclosed herein can be formed using photolithographic techniques. For example, the at least one reflective element 50 can be defined using a gray-scale photo-mask followed by RIE using the substrate 20 as the etch stop. As another example, low pressure chemical vapor deposition (LPCVD) or plasma assisted chemical vapor deposition can be used to deposit a SiₓNi₁₋ₓ or SiₓO_{y}N_{1-x-y} thin-film layer on the first side 21 of the substrate 20. A hole can be opened in this thin-film layer to define the area in which the reflective element 50 is subsequently formed. Anisotropic wet etchant can be used to etch the waveguide 30, thereby exposing a crystalline plane of the waveguide 30, due to the etch rate difference along different crystalline orientations. The reflective element 50 can comprise this crystalline plane. For example, the waveguide 30 and the substrate can both comprise silicon, with the silicon of the substrate 20 having a (001) crystal orientation. KOH, tetramethylammonium hydroxide (TMAH), a mixed solution of KOH plus alcohol, or other silicon wet etchants can be used to etch a portion of the silicon waveguide 30, forming a (011) or (111) planar surface at the first end 31 of the waveguide 30. This planar surface can be at an angle relative to the first side 21 of the substrate 20 (e.g., a 45° for the (011) planar surface or a 54.7° angle for the (111) planar surface, relative to the top surface of the substrate 20, generally parallel to the (001) planes of the underlying silicon substrate 20). The at least one reflective element 50 formed using wet-chemical etching can have a desired degree of surface flatness, so as to cause less scattering of a collimated light impinging its reflective surface.

The at least one hole 40 can comprise an array of holes 40 each extending from the second side 22 of the substrate 20 towards the first side 21 of the substrate 20 and that are spaced from one another at predetermined intervals. The at least one hole 40 can extend into the substrate 20 towards the first side 21 by 200 to 700 microns, depending on the thickness of the substrate 20 being used. The distribution of the holes 40 can be selected to facilitate convenience of making connections to other components, such as electrical amplifiers, optical modulators, and modulator drivers, of the optical communication system. For example, a chess-board-type of arrangement can be used with a hole center to adjacent hole center distance of 250 microns or 127 microns along two perpendicular directions. The holes 40 can be sized or otherwise configured to receive optical fibers 70 inserted into the holes 40 from the second side 22 of the substrate 20, as schematically illustrated by FIG. 1B, and to confine movement of the fiber 70 once affixed in the hole 40. For example, the at least one hole 40 can have a substantially circular cross-section in a plane generally perpendicular to the hole 40 or generally parallel to the first side 21 and the second side 22 (e.g., the hole 40 can extend perpendicularly through at least a portion of the substrate 20). The substantially circular cross-section of the hole 40 can have a diameter (e.g., between 125 microns and 150 microns) or perimeter that is substantially the same or larger than the corresponding diameter (e.g., 125 microns) or perimeter of the optical fiber 70 that is to be inserted into the hole 40. Other sizes and shapes of the cross-section of the hole 40 are also compatible with the systems and methods disclosed herein.

The hole 40 can comprise a first portion 41 extending a first distance from the second side 22 of the substrate 20 towards the first side 21 of the substrate 20 and a second portion 42 extending a second distance from the first portion 41 towards the first side 21 of the substrate 20. For example, the first portion 41 schematically illustrated by FIG. 1B is longer than the second portion 42. For example, the length of the second portion 42 can be between 2 microns to 50 microns, and can be shorter than the length of the first portion 41 (which can be between 200 microns and 700 microns).

The first portion 41 and the second portion 42 can be generally co-axial with one another, as schematically illustrated by FIG. 1B and FIG. 1C. The first portion 41 can have a first cross-sectional shape with a first geometric parameter (e.g., diameter, width, or perimeter) in a plane generally perpendicular to the first portion 41 or generally parallel to the first side 21 and the second side 22 of the substrate 20. The second portion 42 can have a second cross-sectional shape with a second geometric parameter (e.g., diameter, width, or perimeter) in a plane generally perpendicular to the first portion 41 or generally parallel to the first side 21 and the second side 22 of the substrate 20. The second geometric parameter can be smaller than the first geometric parameter. As schematically illustrated by FIG. 1B, the second portion 42 can have a second width W₂ that is smaller than a first width W₁ of the first portion 41. For example, for a first portion 41 and a second portion 42 each with a generally circular cross-section, the width or diameter of the first portion 41 can be equal to or larger than the outer diameter of an optical fiber 70 (e.g., diameter of the first portion 41 can be in a range between 125 microns and 150 microns) and the width or diameter of the second portion 42 can be equal to or larger than the diameter of the core region of the optical fiber 70 (depending on fiber type) (e.g., diameter of the second portion 42 can be in a range between about 10 microns to 62.5 microns, between 20 microns to 120 microns, or between 52 microns and 100 microns) but smaller than the outer diameter of the optical fiber 70 (e.g., 125 microns). The size of the second portion 42 can be selected such that it does not block light from the core of the fiber 70, but only blocks light from the cladding of the fiber 70. The diameter of the first portion 41 can be between 2 microns to 10 microns larger than that of the second portion 42.

The at least one hole 40 of the systems and methods disclosed herein can be formed using photolithographic techniques. For example, as disclosed more fully below, the at least one hole 40 can be etched into the substrate 20 from the second side 22 of the substrate 20 using a deep reactive ion etching (DRIB) process.

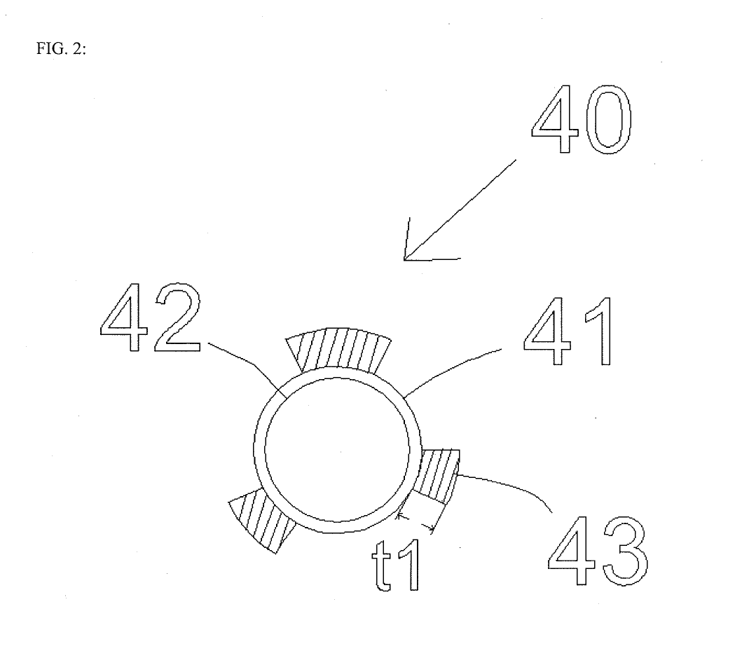

FIG. 2 schematically illustrates a top down view of an example hole 40 etched into the second side 22 of the substrate 20. The first portion 41 is denoted by the outer circle, and the second portion 42 is denoted by the inner circle. The sizes of the first portion 41 and the second portion 42 can be selected such that the optical fiber 70 can be inserted into the first portion 41 but not in the second portion 42, whereby the first portion 41 provides the mechanical space for the inserted fiber 70 and the second portion 42 provides a mechanical stop to further insertion of the fiber 70.

As schematically illustrated by FIG. 2, the hole 40 can further comprise a third portion 43 extending outwardly from the first portion 41 and extending from the second side 22 towards the first side 21 of the substrate 20. The third portion 43 can be configured to receive an adhesive (e.g., glue, epoxy, polymer) denoted by hatching in FIG. 2 and configured to affix the portion of the optical fiber 70 inserted within the hole 40. While FIG. 2 shows the third portion 43 as having a cross-sectional shape with three generally radial extensions joined to the first portion 41, other shapes and numbers of extensions are also compatible with the systems and methods disclosed herein. The length of the third portion 43 in a direction extending towards the first side 21 can be between 5 microns and 300 microns shorter than that of the first portion 41. The radial dimension t₁ of the third portion 43 (shown by the hatched pattern in FIG. 2) can be between 2 microns and 50 microns. The hole 40 can be configured such that the non-etched substrate 20 provides mechanical support to the fiber 70 to be inserted, and the etched portions provide space to inject the adhesive to fix the fiber 70 within the hole 40. For example, the third portion 43 can advantageously be non-continuous along the angular direction, as schematically illustrated by FIG. 2, such that its larger size does not affect the stability of the inserted fiber 70 before it is affixed within the hole 40 by the adhesive.

The optical system 10 can further comprise at least one lens 80 or other type of focusing element at the end of the at least one hole 40 closest to the at least one reflective element 50 or between the at least one hole 40 and the at least one reflective element 50. The lens 80 is configured to focus light propagating through the at least one lens 80 and between the at least one hole 40 and the at least one reflective element 50. The lens 80 can comprise a portion of the substrate 20 shaped to refract and focus light propagating through the portion of the substrate 20. For example, as schematically illustrated by FIG. 1B, the lens 80 comprises a portion of the substrate 20 formed at the end of the hole 40 closest to the first side 21 of the substrate 20 and spaced from the first side 21 of the substrate 20. For example, the lens 80 can have a curved shape with rotational symmetry about the central axis of the hole 40. In configurations in which the lens 80 is formed from a portion of the substrate 20, the lengs 80 comprises the same material as does the substrate 20.

The gap between the lens 80 and the first side 21 can be particularly advantageous for systems and methods disclosed herein in which the RIE process is used to form the at least one hole 40. Due to the non-uniformity of RIE processes, etching a plurality of holes 40 into the substrate 20 can result in a distribution of etch depths, and hence a distribution of hole depths. Leaving a gap between the lens 80 and the first side 21 of the substrate 20 can advantageously prevent the situation wherein the hole 40 is etched completely through the substrate 20 and reaching into the waveguide 30. The existence of this gap can also advantageously provide mechanical support to the fiber 70 when it is inserted into the hole 40. For example, the gap can be between 5 microns and 20 microns. The size of the gap can be selected to be small enough to provide the desired optical properties while being large enough to provide the desired amount of mechanical strength of the remaining material between the lens 80 and the first side 21 of the substrate 20 for the intended application.

The alignment of the waveguide 30, the reflective element 50, the lens 80, and the fiber 70 within the hole 40 is configured to maximize the amount of light transmitted from the waveguide 30 and coupled into the fiber 70 or transmitted from the fiber 70 coupled into the waveguide 30. Free space optics can be used to guide the position relationship of these three structures. If the reflective element 50 comprises a mirror that forms a 45° angle to the first side 21 of the substrate 20, then the hole 40 and the fiber 70 within the hole 40 can be positioned immediately underneath the mirror. If the angle between the mirror and the first side 21 of the substrate 20 is 54.7°, then the hole 40 and the fiber 70 within the hole 40 can be offset accordingly from directly below the mirror (e.g., to the left of the position shown schematically in FIG. 1B).

The optical system 10 can further comprise at least one optical fiber 70 within the at least one hole 40 and in optical communication with the at least one reflective element 50. Examples of optical fibers 70 compatible with the systems and method disclosed herein include, but are not limited to, single-mode fibers, multimode fibers, lens fibers, and polarization-maintaining fibers.

The optical system 10 can further comprise at least one optical device 90 in optical communication with the at least one optical waveguide 30. For example, the at least one optical device 90 can comprise an array of optical devices 90 positioned to be in optical communication with an array of optical waveguide 30 as disclosed herein. Examples of optical devices 90 compatible with the systems and method disclosed herein include, but are not limited to, light sources (e.g., edge emitting lasers, distributed feedback (DFB) lasers, Fabry-Perot lasers, light-emitting diodes) and light detectors (e.g., photodetectors, photo-transistors) disposed at suitable locations at the first side 21 of the substrate 20, aligning themselves to the waveguides 30. Alignment of optical devices 90 with respect to the waveguides 30 can be achieved by placing the flip-chip bonding pads at photolithography-defined locations for light sources. Detectors can be fabricated on top of the substrate 20, so that their relative positions are defined by photolithography. These optical devices 90 can be flip-chip bonded to the substrate 20, with their relative positions with respect to the other components of the optical system 10 defined by the flip-chip alignment process. As schematically illustrated by FIG. 1B, solder and under-bump-metal film 91 can be used to bond the optical device 90 and the substrate 20 together. This bonding can be assisted by additional epoxy or generalized glue dispensed underneath the optical devices 90 to hold them onto the substrate 20. Optical devices 90 comprising photodetectors can be formed on the first side 21 of the substrate 20 using selective epitaxial growth of a signal-absorbing material followed by photolithography and RIE steps.

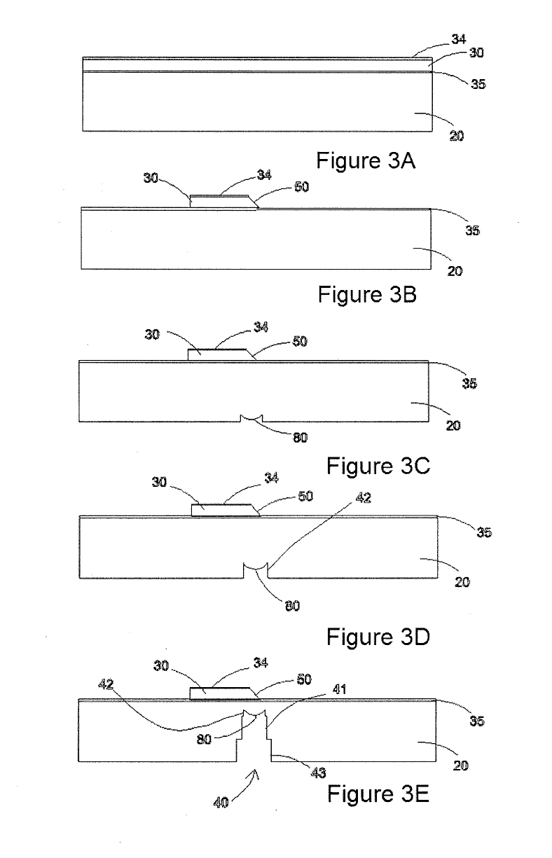

FIGS. 3A-3E schematically illustrate an example process flow using a series of cross-sectional views of the waveguide 30, reflective element 50, lens 80, and hole 40 for fiber insertion by way of the second side 22 of the substrate 20 in accordance with systems and methods disclosed herein. FIG. 3A schematically illustrates the cross section of a substrate 20 (e.g., chip of the starting semiconductor wafer). Material to be used to form the waveguide 30 (including the core 33, upper cladding 34, and lower cladding 35) resides on the first side 21 (e.g., the top side) of the substrate 20. FIG. 3B schematically illustrates the cross section after the waveguide 30 is formed, and the reflective element 50 (e.g., mirror) is formed using a portion of the waveguide 30, as disclosed herein. FIG. 3C schematically illustrates the cross section after the lens 80 is formed on the second side 22 (e.g., the bottom side) of the substrate 20. For example, the lens 80 can be formed using a gray-scale photo-mask and photolithography steps, followed by RIE. The alignment of lens 80 with respective to the reflective element 50 can be defined by a top-to-bottom side photolithography step, depending on the angle between the reflective element 50 and the first side 21 of the substrate 20. From a device processing perspective, forming the reflective element 50 prior to forming the backside hole 40 can be performed so as to finish one side then moving on to the other side. FIG. 3D schematically illustrates the cross section after the initial etch formation of the lens 80 and a further etch step that can make the lens 80 recessed into the substrate 20, forming the second portion 42 of the hole 40. A second photolithography step can be performed to align the first portion 41 of the hole 40 to the existing second portion of the hole 42, and a longer etch can be conducted which forms the first portion 41 of the hole 40, and pushes both the lens 80 and the second portion 42 of the hole 40 further into the substrate 20. The first etch can maintain an etch selectivity of about 1:1 between the masking material (e.g., photoresist) and the material of the substrate 20, so as to transfer the pattern from the grey-scale lithography into the substrate 20. Alternatively, the second etch can simply drill the hole from the second side 22 toward the first side 21 by using a very high selectivity between the msking material and the material of the substrate 20. For the second etch, a “bosch etch process” in a common DRIE tool can be used, and for the first etch, a chlorine- or HBR-based etch chemistry can be used in a remote plasma-based etch tool. FIG. 3E schematically illustrates the cross section after a third portion 43 of the hole 40 is formed by a photolithography step and etching into the substrate 10 (e.g., having the cross-sectional shape shown in FIG. 2). The third portion 43 can be formed in a separate etch, or can be formed with the formation of the first portion 41 in a single etch step. As disclosed herein, the third portion 43 is configured to receive an adhesive (e.g., glue, epoxy, polymer) to affix the fiber 70 mechanically within the hole 40.

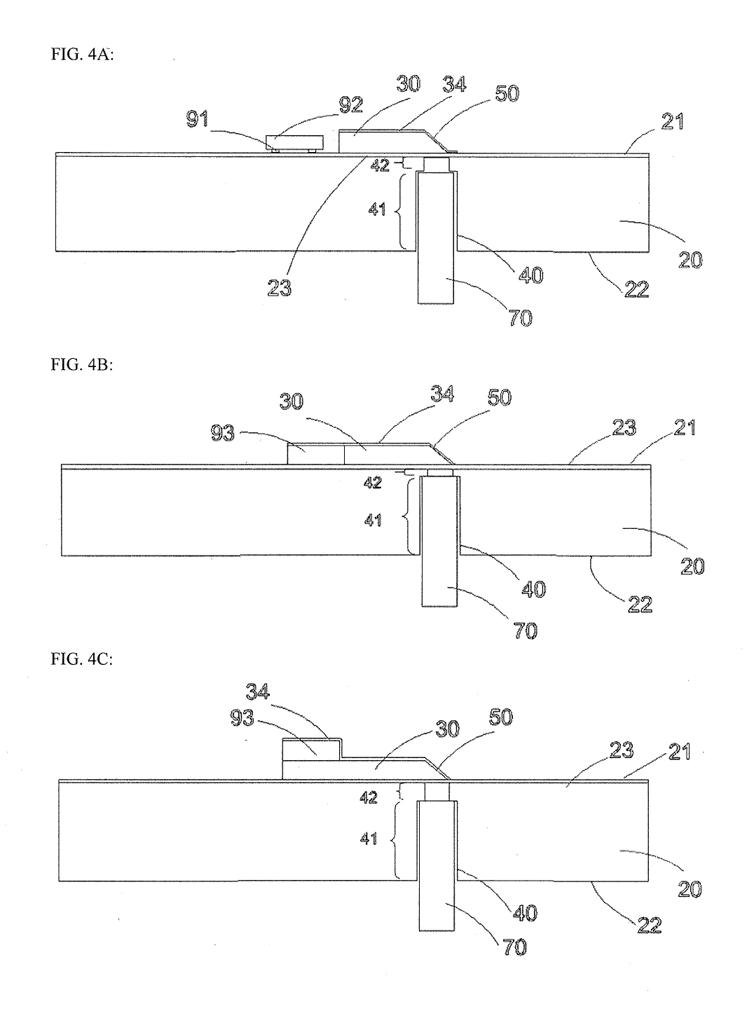

FIG. 4A schematically illustrates a cross-sectional view of an example optical system 10, in which the substrate 20 comprises a silicon-on-insulator (SOI) wafer in accordance with systems and methods disclosed herein. The substrate 20 can comprise silicon and can comprise an buried oxide (BOX) layer 23, which can have a thickness in a range of 0.1 micron to 20 microns. The waveguide 30 can comprise silicon and can have a thickness in a range of 0.25 micron to 13 microns. The BOX layer 23 can serve as the lower cladding 35 for the silicon waveguide 30. The optical device 90 (e.g., light source 92) can be coupled to the substrate 20 by a flip-chip alignment process using a solder and under-bump-metal film 91.

The BOX layer 23 can also serve as the stop layer during the formation of the hole 40 using an RIE process. In the semiconductor industry, an RIE etch selectivity between silicon and silicon dioxide can range from 5 to 100 depending on the etch chemistry and machine. For the example optical system 10 of FIG. 4A, the hole 40 can stop at the bottom of the BOX layer 23 without having hole depth uniformity problem when a plurality of holes 40 are etched into the silicon substrate 20, owing to the much slower etch rate of oxide in comparison to silicon. The inserted fiber 70 can be brought very close to the reflective element 50, such that a lens can be omitted between the waveguide 30 and the fiber 70 since the distance that light coming out of the waveguide 30 propagates before impinging the fiber 70 is sufficiently small such that the light has not diverged into too big a spot size.

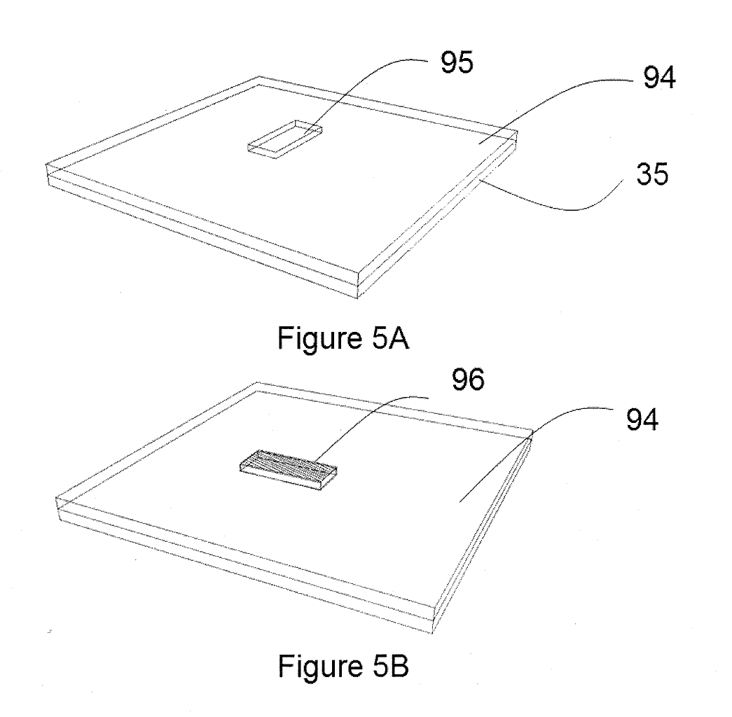

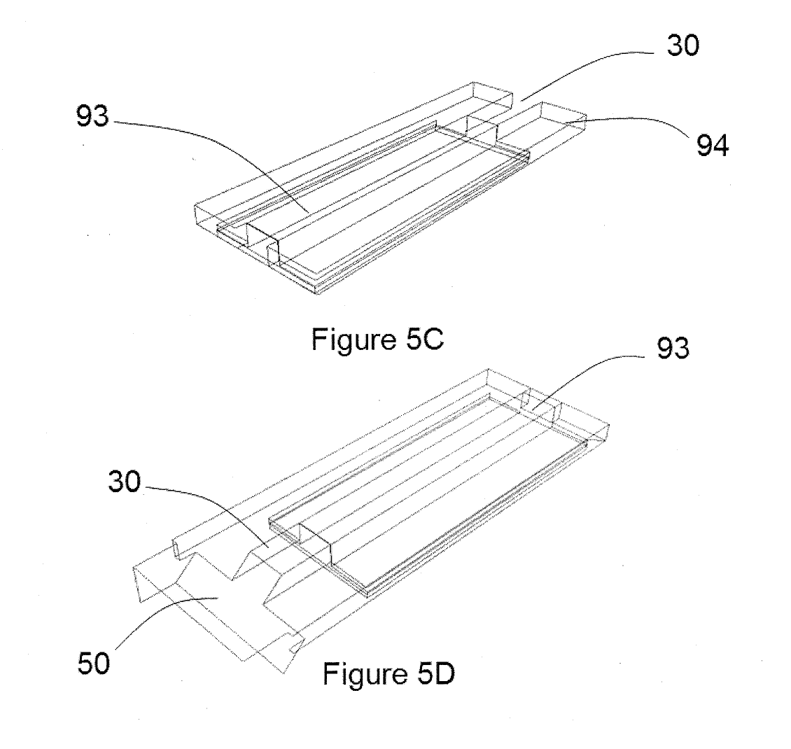

FIG. 4B schematically illustrates a cross-sectional view of an example optical system 10 in which the substrate 20 comprises a SOI wafer and the optical device 90 comprises a waveguide detector 93 such that light transmitted by the waveguide 30 is directly coupled into the waveguide detector 93 in accordance with systems and methods disclosed herein. FIGS. 5A-5D schematically illustrate an example process flow using a series of trimetric views of the formation of the waveguide 30 and the waveguide detector 93 of FIG. 4B in accordance with systems and methods disclosed herein. FIG. 5A schematically illustrates the starting waveguide material 94, which resides on top of the material for the lower cladding 35, and a hole or pit 95 (e.g., box-shaped or rectangular) etched into the SOI starting waveguide material 94 (e.g., silicon with an oxide lower cladding 35). Silicon oxide or nitride can be used as the RIE hard mask. Selective epitaxial growth of light absorbing material 96 (e.g., germanium or GeₓSi₁₋ₓ alloy) can then be grown into the pit 95 to fill the pit 95, as schematically illustrated by FIG. 5B. A rectangular shape mask can then be used to pattern the elogated shape ridge waveguide 30 in an RIE process in which both the waveguide material 94 and the light absorbing material 96 are etched simultaneously. FIG. 5C schematically illustrates the resulting waveguide 30 and waveguide detector 93 as viewed from the waveguide detector 93 side. FIG. 5D schematically illustrates the trimetric view of the waveguide 30 after the reflective element 50 is etched into an end of the waveguide 30. The waveguide detector 93 can have the same width and height as the waveguide 30 to which it is directly coupled. The waveguide detector 93 can be physically connected to the waveguide 30 to which it is directly coupled, leading to normal incidence of light leaving the waveguide 30 and impinging the waveguide detector 93.

FIG. 4C schematically illustrates a cross-sectional view of an example optical system in which the substrate 20 comprises a SOI wafer and the optical device 90 comprises a waveguide detector 93 such that light transmitted by the waveguide 30 is evanescently coupled into the waveguide detector 93 in accordance with systems and methods disclosed herein. For example, the waveguide detector 30 can be formed by selective epitaxial growth of a light absorbing material 96 (e.g., germanium or GeₓSi₁₋ₓ alloy) on top of the waveguide 30, so light propagating within the waveguide 30 will be evanescently coupled into the waveguide detector 93. The starting waveguide material 94 can be patterned using photo-lithography and RIE. A thin layer of silicon dioxide or nitride can be deposited and a hole or pit can be etched above the waveguide 30, in which selective epitaxial growth of the light absorbing material 96 can be performed, thereby forming the waveguide detector 93. Standard doping and metal contact formation can be then performed to electrically connect the waveguide detector 93 to corresponding electrical circuitry.

The optical system 10 can be used to transmit light between the at least one optical device 90 and the at least one optical fiber 70 inserted into the at least one hole 40. The transmitted light can propagate through the at least one optical waveguide 30, can be reflected by the at least one reflective element 50, and can propagate through the at least one hole 40. For example, light from at least one light source 92 can be coupled into the at least one waveguide 30, reflected by the at least one reflective element 50, and transmitted into the at least one optical fiber 70 within the at least one hole 40. As another example, light from the at least one optical fiber 70 can be reflected by the at least one reflective element 50, transmitted into the at least one waveguide 30, and coupled into at least one waveguide detector 93, either directly or evanescently.

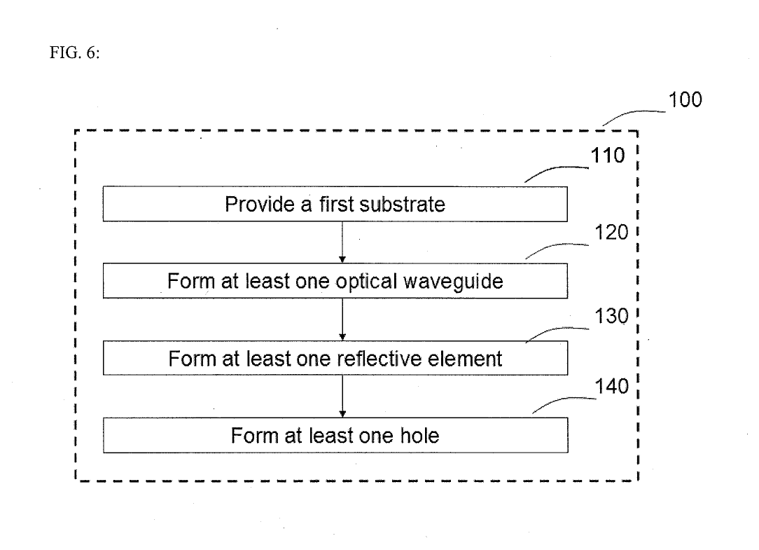

FIG. 6 is a flow diagram of an example method 100 of fabricating an example optical system 10 in accordance with systems and methods disclosed herein. While the method 100 is described by referring to the components and structures disclosed above, the method 100 is compatible with other structures and combinations of components than those disclosed above. In an operational block 110, the method 100 comprises providing a first substrate 20 comprising a first side 21 and a second side 22 facing generally opposite to the first side 21. In an operational block 120, the method 100 further comprises forming at least one optical waveguide 30 extending along at least a portion of the first side 21. In an operational block 130, the method 100 further comprises forming at least one reflective element 50 at the first side 21. In an operational block 140, the method 100 further comprises forming at least one hole extending from the second side 22 towards the first side 21. The at least one reflective element 50 can be in optical communication with the at least one optical waveguide 30 and with the at least one hole 40. The at least one reflective element 50 can be configured to deflect light between the at least one optical waveguide 30 and the at least one hole 40.

The various operational blocks of the method 100 can each comprise one or more steps or processes. The operational blocks can be performed in the order shown in FIG. 6 or in any order while remaining compatible with the systems and methods described herein. Furthermore, the steps or processes of one operational block can be performed contiguously with one another, or can be interleaved with one or more steps or processes of one or more other operational blocks. In addition, one or more steps or processes of one or more operational blocks can be used to form multiple structures that are disclosed in FIG. 6 to be formed in separate operational blocks.

The first substrate 20 can comprise an optical layer at the first side 21, with the optical layer comprising a core layer 31 and a lower cladding layer 35. Forming the at least one optical waveguide 30 in the operational block 120 can comprise etching the optical layer and forming an upper cladding layer 34 on the core layer 31.

Forming the at least one hole 40 in the operational block 140 can comprise etching the first substrate 20 from the second side 22 towards the first side 21. Etching the first substrate 20 from the second side 22 towards the first side 21 can comprise forming a first portion of the at least one hole 40 by etching the first substrate 20. The first portion can extend a first distance from the second side 22 towards the first side 21. The first portion can have a first cross-sectional shape in a plane generally perpendicular to the first portion, and the first cross-sectional shape can have a first perimeter. Etching the first substrate 20 can further comprise forming a second portion of the at least one hole 40 by etching the first substrate 20. The second portion can extend a second distance from the first portion towards the first side 21. The second portion can have a second cross-sectional shape in a plane generally perpendicular to the first portion. The second cross-sectional shape can have a second perimeter smaller than the first perimeter.

Forming the at least one hole 40 can further comprise forming at least one focusing element 80 between the at least one hole 40 and the at least one reflective element 50. The at least one focusing element 80 can be configured to focus light propagating through the at least one focusing element 80 between the at least one hole 40 and the at least one reflective element 50. Forming the at least one focusing element 80 can comprise shaping a portion of the first substrate 20 using gray-scale mask lithography followed by RIE.

Forming the at least one reflective element 50 in the operational block 130 can comprise shaping a portion of the optical layer using grey-scale mask lithography followed by RIE using the first substrate 20 as an etch stop. Alternatively or in addition to the above, forming the at least one reflective element 50 in the operational block 130 can comprise depositing a barrier layer over the optical layer, forming a hole in the barrier layer to expose the underlying optical layer, and anisotropically etching a portion of the underlying optical layer.

The method 100 can further comprise inserting at least one optical fiber 70 into the at least one hole 40 until the second portion of the at least one hole 40 stops the insertion of the at least one optical fiber 70. The method 100 can further comprise placing at least one optical device 90 in optical communication with the at least one optical waveguide 30. The at least one optical device 90 can comprise at least one light source 92 residing on a second substrate, and placing the at least one optical device in optical communication with the at least one optical waveguide 30 can comprise coupling the second substrate to the first substrate 20 (e.g., by a flip-chip process). The at least one optical device 90 can comprise at least one light detector 93 and placing at least one optical device 90 in optical communication with the at least one optical waveguide 30 can comprise forming the at least one light detector 93 at the first side 21.

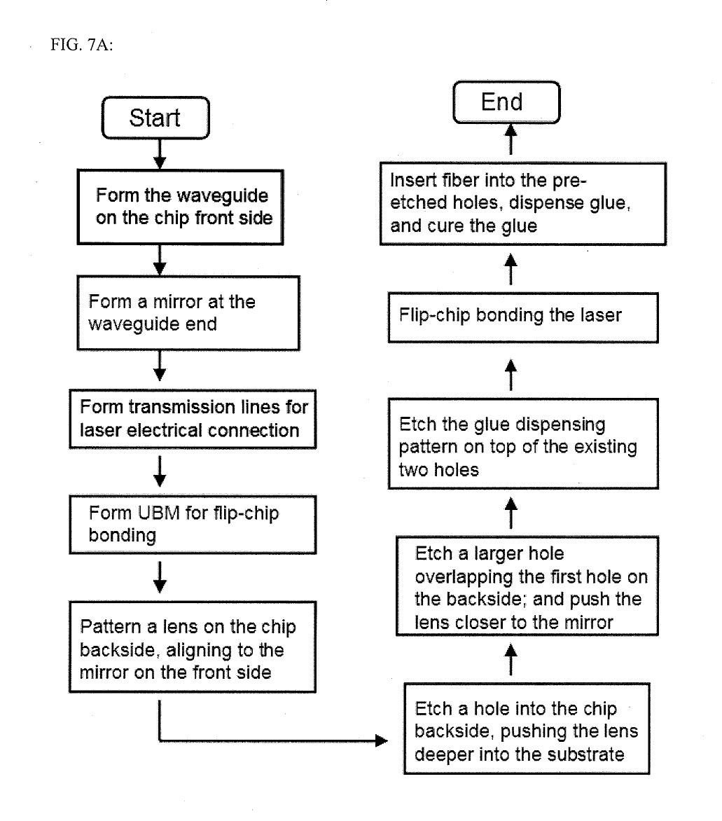

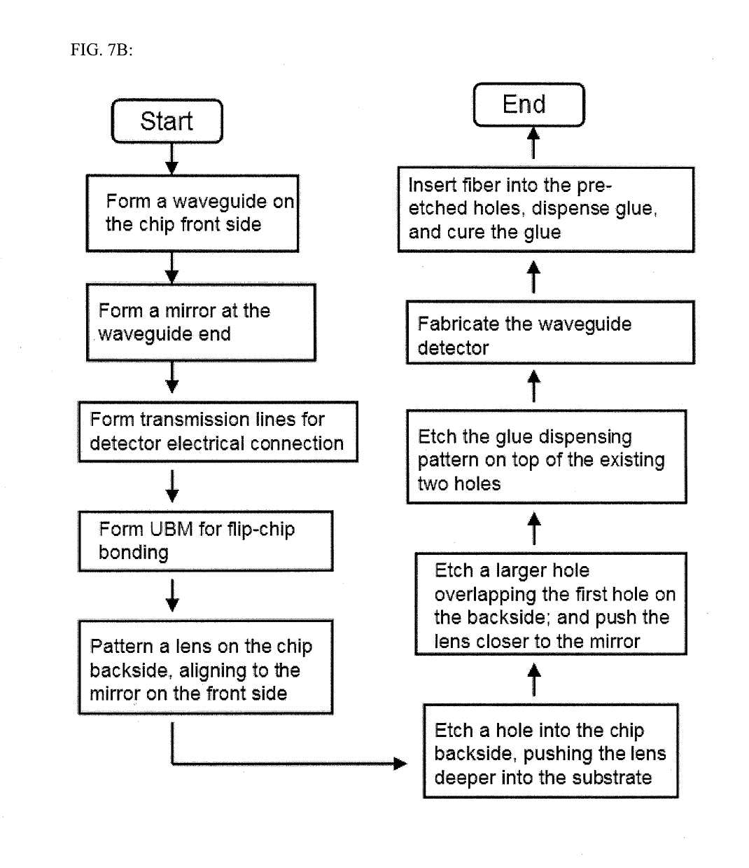

FIG. 7A is a flow diagram of an example process flow to assemble an edge emitting laser to an example optical system so as to couple light from the laser to a fiber in accordance with systems and methods disclosed herein.

FIG. 7B is a flow diagram of an example process flow to assemble a waveguide detector to an example optical system device so as to couple light from a fiber to the detector in accordance with systems and methods disclosed herein. Aspects of the various steps in the flow diagrams of FIGS. 7A and 7B have been described above, while other steps are common practice in the semiconductor industry. In FIGS. 7A and 7B, “UBM” denotes “under bump metallurgy, and refers to a stack of metallization used between a semiconductor chip and the solder.

Various configurations have been described above. Although this invention has been described with reference to these specific configurations, the descriptions are intended to be illustrative of the invention and are not intended to be limiting. Various modifications, combinations of the various features, and applications may occur to those skilled in the art without departing from the true spirit and scope of the invention as defined in the appended claims.

What is claimed is:

1. An optical system comprising:
a substrate comprising a first side and a second side facing generally opposite to the first side;
at least one optical waveguide extending along at least a portion of the first side;
at least one hole extending from the second side towards the first side; and
at least one reflective element at the first side, the at least one reflective element in optical communication with the at least one optical waveguide and with the at least one hole, the at least one reflective element configured to deflect light between the at least one optical waveguide and the at least one hole.

2. The optical system of claim 1, wherein the at least one optical waveguide comprises an array of optical waveguides, the at least one hole comprises an array of holes, and the at least one reflective element comprises an array of reflective elements.

3. The optical system of claim 1, wherein the substrate comprises a semiconductor material.

4. The optical system of claim 3, wherein the semiconductor material comprises silicon, the at least one optical waveguide comprises silicon, and the substrate comprises an oxide layer between the at least one hole and the at least one optical waveguide.

5. The optical system of claim 1, wherein the substrate comprises at least one focusing element between the at least one hole and the at least one reflective element, the at least one focusing element configured to focus light propagating through the at least one focusing element and between the at least one hole and the at least one reflective element.

6. The optical system of claim 1, wherein the at least one hole has a generally circular cross-section in a plane generally perpendicular to the at least one hole, the generally circular cross-section having a diameter between 125 microns and 150 microns.

7. The optical system of claim 1, wherein the at least one hole comprises:
a first portion extending a first distance from the second side towards the first side, the first portion having a first cross-sectional shape in a plane generally perpendicular to the first portion, the first cross-sectional shape having a first geometric parameter; and
a second portion extending a second distance from the first portion towards the first side, the second portion having a second cross-sectional shape in a plane generally perpendicular to the first portion, the second cross-sectional shape having a second geometric parameter smaller than the first geometric parameter.

8. The optical system of claim 1, wherein the at least one hole is configured to receive a portion of an optical fiber and an adhesive configured to affix the portion of the optical fiber within the at least one hole.

9. The optical system of claim 1, further comprising at least one optical fiber within the at least one hole and in optical communication with the at least one reflective element, the optical system further comprising at least one optical device in optical communication with the at least one optical waveguide.

10. The optical system of claim 9, wherein the at least one optical device comprises at least one light source or at least one light detector.

11. A method of coupling light between at least one optical fiber and at least one optical device, the method comprising:
providing an optical system comprising:
a substrate comprising a first side and a second side facing generally opposite to the first side;
at least one optical waveguide extending along at least a portion of the first side;
at least one hole extending from the second side towards the first side; and
at least one reflective element at the first side, the at least one reflective element in optical communication with the at least one optical waveguide and with the at least one hole, the at least one reflective element configured to deflect light between the at least one optical waveguide and the at least one hole;
providing at least one optical device in optical communication with the at least one optical waveguide;
providing at least one optical fiber within the at least one hole such that the at least one optical fiber is in optical communication with the at least one reflective element; and
transmitting light between the at least one optical device and the at least one optical fiber, wherein the transmitted light propagates through the at least one optical waveguide, is reflected by the at least one reflective element, and propagates through the at least one hole.

12. A method of fabricating an optical system, the method comprising:
providing a first substrate comprising a first side and a second side facing generally opposite to the first side;
forming at least one optical waveguide extending along at least a portion of the first side;
forming at least one hole extending from the second side towards the first side; and
forming at least one reflective element at the first side, the at least one reflective element in optical communication with the at least one optical waveguide and with the at least one hole, the at least one reflective element configured to deflect light between the at least one optical waveguide and the at least one hole.

13. The method of claim 12, wherein the first substrate comprises an optical layer at the first side, the optical layer comprising a core layer and a lower cladding layer, and forming the at least one optical waveguide comprises etching the optical layer and forming an upper cladding layer on the core layer.

14. The method of claim 13, wherein forming the at least one reflective element comprises shaping a portion of the optical layer using gray-scale mask lithography followed by reactive-ion etching using the first substrate as an etch stop.

15. The method of claim 13, wherein forming the at least one reflective element comprises depositing a barrier layer over the optical layer, forming a hole in the barrier layer to expose the underlying optical layer, and anisotropically etching a portion of the underlying optical layer.

16. The method of claim 12, wherein forming the at least one hole comprises etching the first substrate from the second side towards the first side.

17. The method of claim 16, wherein forming the at least one hole further comprises forming at least one focusing element between the at least one hole and the at least one reflective element, the at least one focusing element configured to focus light propagating through the at least one focusing element between the at least one hole and the at least one reflective element, wherein forming the at least one focusing element comprises shaping a portion of the first substrate using gray-scale mask lithography followed by reactive-ion etching.

18. The method of claim 16, wherein etching the first substrate from the second side towards the first side comprises:
forming a first portion of the at least one hole by etching the first substrate, the first portion extending a first distance from the second side towards the first side, the first portion having a first cross-sectional shape in a plane generally perpendicular to the first portion, the first cross-sectional shape having a first perimeter; and
forming a second portion of the at least one hole by etching the first substrate, the second portion extending a second distance from the first portion towards the first side, the second portion having a second cross-sectional shape in a plane generally perpendicular to the first portion, the second cross-sectional shape having a second perimeter smaller than the first perimeter.

19. The method of claim 18, further comprising inserting at least one optical fiber into the at least one hole until the second portion of the at least one hole stops the insertion of the at least one optical fiber.

20. The method of claim 12, further comprising placing at least one optical device in optical communication with the at least one optical waveguide.

21. The method of claim 20, wherein the at least one optical device comprises at least one light source residing on a second substrate, and placing the at least one optical device in optical communication with the at least one optical waveguide comprises coupling the second substrate to the first substrate.

22. The method of claim 20, wherein the at least one optical device comprises at least one light detector, and placing the at least one optical device in optical communication with the at least one optical waveguide comprises forming the at least one light detector at the first side.
